(19) United States
(12) Patent Application Publication
(10) Pub. No.: US 2024/0208590 A1
(43) Pub. Date: Jun. 27, 2024

(54) BACK PANEL ASSEMBLY FOR VEHICLE

(71) Applicants: Hyundai Motor Company, Seoul (KR); Kia Corporation, Seoul (KR)

(72) Inventors: Hoje KANG, Hwaseong-Si (KR); Ryunsang YOON, Pyeongchang-Eup (KR)

(73) Assignees: Hyundai Motor Company, Seoul (KR); Kia Corporation, Seoul (KR)

(21) Appl. No.: 18/235,516

(22) Filed: Aug. 18, 2023

(30) Foreign Application Priority Data
Dec. 27, 2022 (KR) 10-2022-0185891

(51) Int. Cl. B62D 33/027

(52) U.S. Cl. CPC B62D 33/0273

(57) ABSTRACT

A back panel assembly forms a lower portion of a tailgate opening at a rear side of a vehicle and includes: a back panel extending from the lower portion of the tailgate opening at the rear side of the vehicle in a horizontal direction of a vehicle body and coupled to the vehicle body; a rear transverse assembly member disposed in the horizontal direction of the vehicle body and coupled to cover a center portion of the back panel; a rear transverse side reinforcement coupled to a lateral portion of the rear transverse assembly member and extending to the outside of the vehicle; and a rear transverse extension member coupled to an upper portion of the rear transverse side reinforcement.

### CROSS-REFERENCE TO RELATED APPLICATION

The present application claims priority to Korean Patent Application No. 10-2022-0185891 filed on Dec. 27, 2022, the entire contents of which is incorporated herein for all purposes by this reference.

### BACKGROUND OF THE PRESENT DISCLOSURE

### Field of the Present Disclosure

The present disclosure relates to a back panel assembly for a vehicle, and to a back panel assembly provided at a side of a rear bumper and configured to open or close a central portion of a tailgate of a vehicle.

### Description of Related Art

In general, a vehicle is provided with a trunk compartment which is a space capable of accommodating luggage. Such a trunk compartment is partitioned from the outside thereof by a back panel assembly that defines a rear portion of the vehicle.

As illustrated in FIG. 1A, FIG. 1B and FIG. 1C, in the case of the back panel assembly generally, a back panel 1 defines the rear portion of the vehicle, and a rear transverse assembly member 2 reinforces rigidity of the back panel 1 while blocking penetration of moisture from an upper side of the back panel 1. The rear transverse assembly member 2 is provided to cover a central part of the back panel 1, and extension members 4 are coupled to upper end portions of two opposite sides of the back panel 1. A reinforcement 3 is disposed between the extension member 4 and the back panel 1 to reinforce rigidity of the back panel 1. The reinforcement 3 and the back panel 1 are coupled by a bulkhead 5.

In the back panel assembly structure generally, the back panel 1 and the reinforcement 3 are connected by the separate bulkhead 5 without being directly connected to each other. For the present reason, there is a problem in that rigidity in a forward/rearward direction is low. In particular, there is a problem in that the separate additional member is used, which causes a problem of an increase in number of components, weight, and costs.

Furthermore, there is also a problem in that rigidity is low because the reinforcement 3 is not directly connected to the rear transverse assembly member 2.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a back panel assembly structure for a vehicle, which is configured for ensuring durability and noise, vibration, and harshness (NVH) performance even though a bulkhead is excluded.

An exemplary embodiment of the present disclosure provides a back panel assembly for a vehicle, which forms a lower portion of a tailgate opening at a rear side of a vehicle, the back panel assembly including: a back panel extending from the lower portion of the tailgate opening at the rear side of the vehicle in a horizontal direction of a vehicle body and coupled to the vehicle body: a rear transverse assembly member disposed in the horizontal direction of the vehicle body and coupled to cover a center portion of the back panel: a rear transverse side reinforcement coupled to a lateral portion of the rear transverse assembly member and extending to the outside of the vehicle; and a rear transverse extension member coupled to an upper portion of the rear transverse side reinforcement.

The back panel assembly according to the exemplary embodiment of the present disclosure may further include a side floor panel coupled to a side end portion of the rear transverse side reinforcement.

Upper and lower end portions of the rear transverse assembly member may be coupled to upper and lower portions of the back panel by welding.

An upper end portion of the rear transverse side reinforcement may be coupled to the upper portion of the back panel by being welded along a single line, and a lower end portion of the rear transverse side reinforcement may be coupled to the lower portion of the back panel by welding.

A lower end portion of the rear transverse extension member may be coupled to a center portion of the rear transverse side reinforcement by welding.

An upper end portion of the rear transverse side reinforcement may be coupled to the upper portion of the back panel by welding, and a lower end portion of the rear transverse side reinforcement may be coupled to the lower portion of the back panel by welding.

An upper portion, a center portion, and a lower portion of an external end portion of the rear transverse side reinforcement may be coupled to a surface of the side floor panel by welding.

An internal end portion of the rear transverse extension member may be coupled to the rear transverse assembly member by welding, and a lower end portion of the rear transverse extension member may be coupled to a center portion of the rear transverse side reinforcement by welding.

An upper end portion of the rear transverse extension member may be coupled to the vehicle body by bolting.

An external surface of the side floor panel may be attached and coupled to a D-pillar reinforcement of the vehicle body by a bonding agent for a structure.

According to the exemplary embodiment of the present disclosure, a bulkhead, which is disposed between the rear transverse side reinforcement and the back panel in the back panel assembly for a vehicle, may be excluded, which may reduce the number of components, weight, and costs.

Furthermore, by adopting a structure in which the rear transverse side reinforcement covers both the rear transverse assembly and the back panel, it is possible to improve rigidity and durability of the vehicle body and ensure NVH performance.

Furthermore, the side floor panel and the D-pillar reinforcement may be coupled by the bonding agent for a structure, which may improve connectivity between the back panel, the side floor panel, and a quarter portion and increase framework rigidity of the vehicle body.

Furthermore, by adopting a structure in which the lower end portion of the rear transverse extension member is coupled to the center portion of the rear transverse side reinforcement, it is possible to increase a size of the tailgate opening and improve user convenience.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A, FIG. 1B and FIG. 1C are views exemplarily illustrating a structure of a back panel assembly for a vehicle in the related art.

FIG. 2 is a front view exemplarily illustrating a structure of a back panel assembly for a vehicle according to an exemplary embodiment of the present disclosure.

FIG. 3 is an exploded perspective view exemplarily illustrating the structure of the back panel assembly for a vehicle according to the exemplary embodiment of the present disclosure.

FIG. 4 is an engaged view of one side coupling portion of the back panel assembly for a vehicle according to the exemplary embodiment of the present disclosure.

FIG. 5 is a cross-sectional view taken along line ‘A-A’ in FIG. 4.

FIG. 6 is a cross-sectional view taken along line ‘B-B’ in FIG. 4.

FIG. 7 is a view exemplarily illustrating a coupling structure between a back panel and a rear transverse side reinforcement of the back panel assembly for a vehicle according to the exemplary embodiment of the present disclosure.

FIG. 8 is a view exemplarily illustrating a coupling structure between the back panel and a rear transverse side reinforcement of a rear transverse extension member of the back panel assembly for a vehicle according to the exemplary embodiment of the present disclosure.

FIG. 9 is a cross-sectional view exemplarily illustrating a coupling structure between a D-pillar reinforcement and a side floor panel of the back panel assembly for a vehicle according to the exemplary embodiment of the present disclosure.

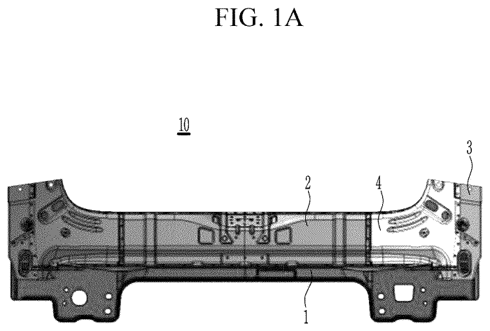

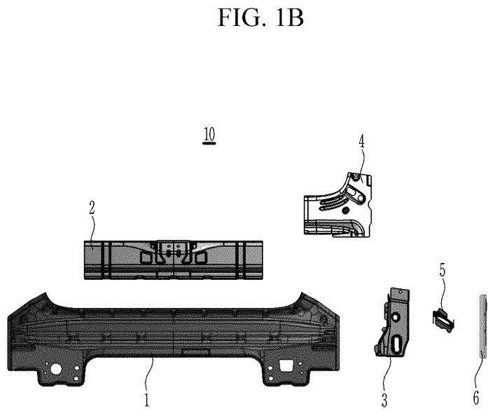

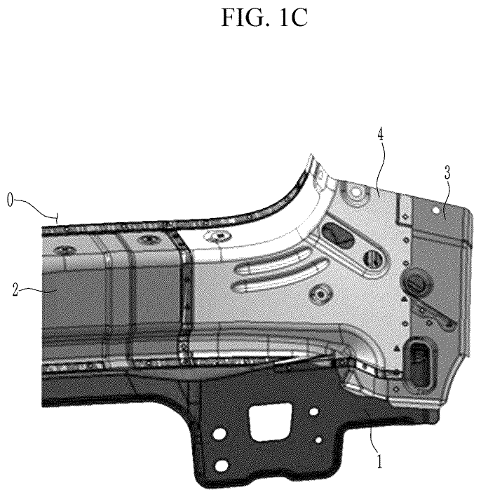

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the accompanying drawings so that those with ordinary skill in the art to which the present disclosure pertains may easily carry out the embodiments. The present disclosure may be implemented in various different ways and is not limited to the exemplary embodiments described herein.

Furthermore, the constituent elements including the same configurations in several embodiments will be assigned with the same reference numerals and described only in the representative embodiment, and only the constituent elements, which are different from the constituent elements according to the representative embodiment, will be described in other exemplary embodiments of the present disclosure.

It is noted that the drawings are schematic and are not illustrated based on actual scales. Relative dimensions and proportions of parts illustrated in the drawings are exaggerated or reduced in size for clarity and convenience in the drawings, and any dimension is just illustrative but not restrictive. The same reference numerals designate the same structures, elements or components illustrated in two or more drawings to exhibit similar characteristics. When one component is referred to as being positioned “above” or “on” another component, one component may be positioned “directly on” another component, and one component can also be positioned on another component with other components interposed therebetween.

The exemplary embodiment of the present disclosure specifically illustrates an example of the present disclosure. As a result, various modifications of the drawings are expected. Therefore, the exemplary embodiments are not limited to specific forms in regions illustrated in the drawings, and for example, include modifications of forms by the manufacture thereof.

Hereinafter, a structure of a back panel assembly 100 for a vehicle according to an exemplary embodiment of the present disclosure will be described in detail with reference to the accompanying drawings.

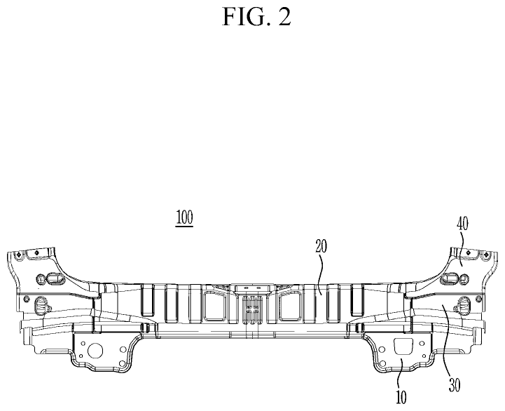

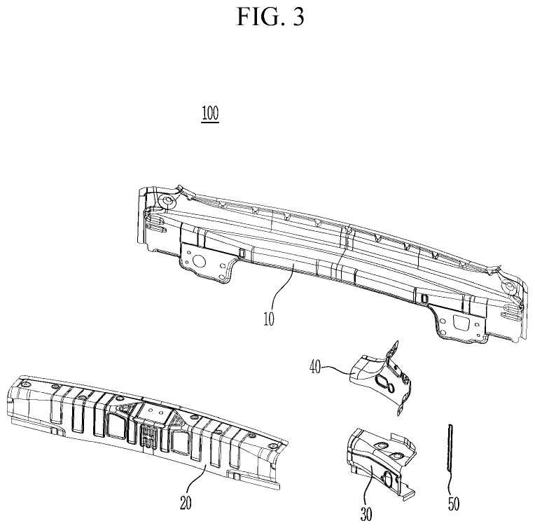

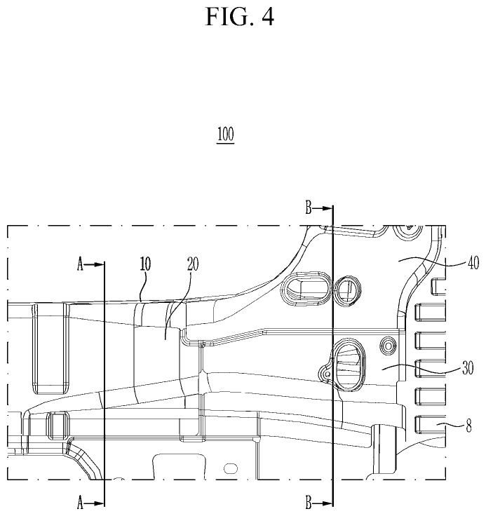

FIG. 2 is a front view exemplarily illustrating a structure of a back panel assembly for a vehicle according to an exemplary embodiment of the present disclosure, FIG. 3 is an exploded perspective view exemplarily illustrating the structure of the back panel assembly for a vehicle according to the exemplary embodiment of the present disclosure, and FIG. 4 is an engaged view of one side coupling portion of the back panel assembly for a vehicle according to the exemplary embodiment of the present disclosure.

With reference to FIG. 2, FIG. 3 and FIG. 4, the back panel assembly 100 for a vehicle according to the exemplary embodiment of the present disclosure includes a back panel 10, a rear transverse assembly member 20 coupled to a front surface of the back panel 10, rear transverse side reinforcements 30 coupled to two opposite side portions of the rear transverse assembly member 20 and extending to the outside of the vehicle, rear transverse extension members 40 coupled to upper portions of the rear transverse side reinforcements 30 and an upper side portion of the rear transverse assembly member 20, and side floor panels 50 coupled to side end portions of the rear transverse side reinforcements 30.

The back panel 10 extends from a lower portion of a tailgate opening at a rear side of the vehicle in a horizontal direction of a vehicle body 8 and is coupled to the vehicle body 8. Like the back panel 10, the rear transverse assembly member 20 is also disposed in the horizontal direction of the vehicle body 8 and coupled to cover a center portion of the front surface of the back panel 10. That is, a lateral portion of the back panel 10 is externally exposed of the rear transverse assembly member 20.

The rear transverse side reinforcements 30 are coupled to the two opposite side portions of the rear transverse assembly member 20 to cover the rear transverse assembly member 20. The rear transverse side reinforcement 30 is coupled to cover the exposed lateral portion of the back panel 10.

The rear transverse extension member 40 is coupled to cover both a part of the upper portion of the rear transverse side reinforcement 30 and a part of the upper portion of the rear transverse assembly member 20. Furthermore, the side floor panel 50 is coupled to the side end portion of the rear transverse side reinforcement 30.

That is, as illustrated in FIG. 4, the back panel 10 is coupled to the vehicle body 8 at the rear side of the vehicle in the horizontal direction of the vehicle body. The rear transverse assembly member 20 is coupled to cover the center portion of the back panel 10. The rear transverse side reinforcement 30 is coupled to cover the lateral portion of the rear transverse assembly 20 and the exposed lateral portion of the back panel 10. The rear transverse extension member 40 is coupled to cover a part, i.e., an upper side of the rear transverse side reinforcement 30 and cover an upper side of the rear transverse assembly member 20.

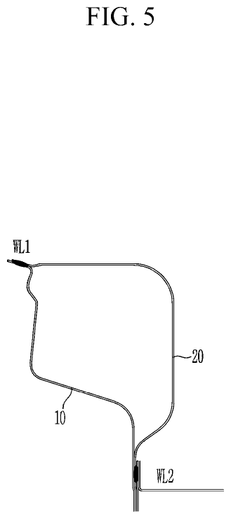

FIG. 5 is a cross-sectional view taken along line ‘A-A’ in FIG. 4.

With reference to FIG. 5, a lower portion of the back panel 10 further protrudes to the rear side of the vehicle body 8 than an upper portion of the back panel 10. The upper portion of the back panel 10 extends toward a front side of the vehicle body 8, and the lower portion of the back panel 10 extends toward a lower side of the vehicle body 8. The rear transverse assembly member 20 is coupled to cover the back panel 10. An upper end portion of the rear transverse assembly member 20 extends toward the upper portion of the back panel 10 and is welded to the upper portion of the back panel 10 (WL1). Furthermore, a lower end portion of the rear transverse assembly member 20 extends toward the lower portion of the vehicle body 8 and is welded to the lower portion of the back panel 10 (WL2).

The upper end portion of the rear transverse assembly member 20 and the upper portion of the back panel 10 may be welded along a single line in the horizontal direction of the vehicle body 8, and the lower end portion of the rear transverse assembly member 20 and the lower portion of the back panel 10 may be welded along a single line in the horizontal direction of the vehicle body 8 (WL1 and WL2).

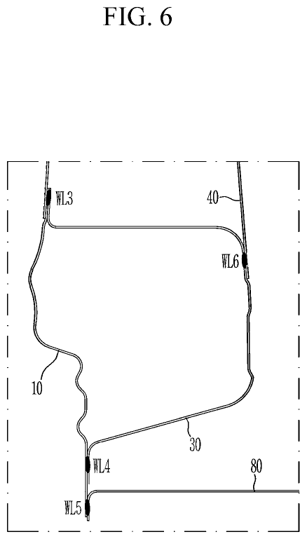

FIG. 6 is a cross-sectional view taken along line ‘B-B’ in FIG. 4.

With reference to FIG. 6, the upper portion of the back panel 10 extends toward the upper side of the vehicle body 8, and the lower portion of the back panel 10 extends toward the lower side of the vehicle body 8. The upper end portion of the rear transverse side reinforcement 30 extends toward the upper side of the vehicle body 8 and is welded to the upper portion of the back panel 10 (WL3). The lower end portion of the rear transverse side reinforcement 30 extends toward the lower side of the vehicle body 8 and is welded to the lower portion of the back panel 10 (WL4). Furthermore, a rear floor panel 80 is welded to the back panel 10 (WL5) at a position below a welding point WL4 between the lower end portion of the rear transverse side reinforcement 30 and the lower portion of the back panel 10.

The upper end portion of the rear transverse side reinforcement 30 and the upper portion of the back panel 10 may be welded along a single line in the horizontal direction of the vehicle body 8, the lower end portion of the rear transverse side reinforcement 30 and the lower portion of the back panel 10 may be welded along a single line in the horizontal direction of the vehicle body 8, and the lower portion of the back panel 10 and the rear floor panel 80 may be welded along a single line in the horizontal direction of the vehicle body 8 (WL3, WL4, and WL5).

Meanwhile, the lower end portion of the rear transverse extension member 40 may be welded to the center portion of the rear transverse side reinforcement 30 and extend toward the upper side of the vehicle body 8 (WL6). That is, the rear transverse extension member 40 is coupled to cover a part of the rear transverse side reinforcement 30. The lower end portion of the rear transverse extension member 40 may be welded to the center portion of the rear transverse side reinforcement 30 along a single line in the horizontal direction of the vehicle body 8 (WL6).

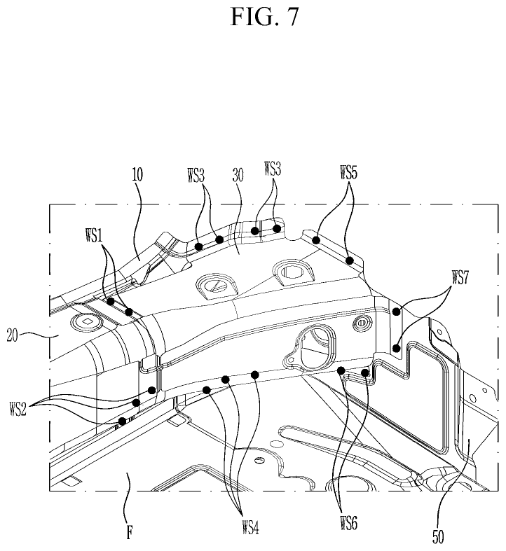

FIG. 7 is a view exemplarily illustrating a coupling structure between the back panel and the rear transverse side reinforcement of the back panel assembly for a vehicle according to the exemplary embodiment of the present disclosure.

With reference to FIG. 7, the rear transverse side reinforcement 30 is point-welded to the side end portion of the rear transverse assembly member 20 at a center portion of the rear side of the vehicle body 8 (WS1 and WS2). The side end portion of the rear transverse assembly member 20 may be coupled to cover the rear transverse side reinforcement 30. The side end portion of the rear transverse side reinforcement 30 may be point-welded to the side end portion of the rear transverse assembly member 20. In the instant case, the side end portion of the rear transverse side reinforcement 30 may be welded to an upper portion of the side end portion of the rear transverse assembly member 20 at two points (WS1) and welded to a lower portion of the side end portion of the rear transverse assembly member 20 at three points (WS2).

Furthermore, the rear transverse side reinforcement 30 may point-welded to the back panel 10 at an edge portion side of the rear side of the vehicle body 8 (WS3 and WS4). The upper end portion of the rear transverse side reinforcement 30 may be point-welded to the upper portion of the back panel 10 (WS3), and the lower end portion of the rear transverse side reinforcement 30 may be coupled by being point-welded to the lower portion of the back panel 10 (WS4). In the instant case, the upper end portion of the rear transverse side reinforcement 30 may be coupled to the upper portion of the back panel 10 by being welded at four 4 points (WS3), and the lower end portion of the rear transverse side reinforcement 30 may be coupled to the lower portion of the back panel 10 by being welded at three points (WS4).

Meanwhile, an external end portion of the rear transverse side reinforcement 30 may be welded to the surface of the side floor panel 50 at six points (WS5, WS6, and WS7). In the instant case, an upper portion, a center portion, and a lower portion of the external end portion of the rear transverse side reinforcement 30 may be coupled to the surface of the side floor panel 50 by being welded at two points.

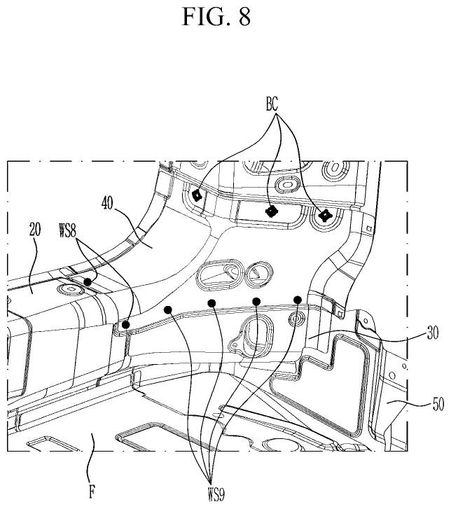

FIG. 8 is a view exemplarily illustrating a coupling structure between the back panel and the rear transverse side reinforcement of the rear transverse extension member of the back panel assembly for a vehicle according to the exemplary embodiment of the present disclosure.

With reference to FIG. 8, the rear transverse extension member 40 may be coupled to cover both a portion of the rear transverse side reinforcement 30 and a portion of the rear transverse assembly member 20. The side end portion of the rear transverse extension member 40 may be welded to the rear transverse assembly member 20 (WS8), the lower end portion of the rear transverse extension member 40 may be welded to the rear transverse side reinforcement 30 (WS9), and the upper end portion of the rear transverse extension member 40 may be coupled to the vehicle body 8 by bolting (BC).

In the instant case, an internal lower end portion of the rear transverse extension member 40 may be coupled to the rear transverse assembly member 20 by being welded at two points (WS8), and the lower end portion of the rear transverse extension member 40 may be coupled to the center portion of the rear transverse side reinforcement 30 by being welded at four points (WS9). Furthermore, the upper end portion of the rear transverse extension member 40 may be coupled to the vehicle body 8 by bolting at three points (BC).

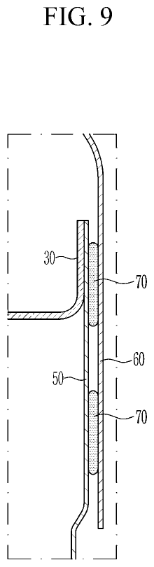

FIG. 9 is a cross-sectional view exemplarily illustrating a coupling structure between a D-pillar reinforcement and the side floor panel of the back panel assembly for a vehicle according to the exemplary embodiment of the present disclosure.

With reference to FIG. 9, an external surface of the side floor panel 50 may be coupled by being attached to a D-pillar reinforcement 60 of the vehicle body 8 by a bonding agent 70 (e.g., tape) for a structure. In the instant case, the bonding agent 70 for a structure may be provided at two points on the external surface of the side floor panel 50. The bonding agent 70 for a structure may be positioned between the D-pillar reinforcement 60 and the coupling portion between the rear transverse side reinforcement 30 and the side floor panel 50 and positioned between the side floor panel 50 and the D-pillar reinforcement 60 at a position below the coupling portion. Therefore, the bonding agent 70 for a structure may connect the external surface of the side floor panel 50 and an internal surface of the D-pillar reinforcement 60.

As described above, according to the exemplary embodiment of the present disclosure, a bulkhead, which is disposed between the rear transverse side reinforcement and the back panel in the back panel assembly for a vehicle, may be excluded, which may reduce the number of components, weight, and costs.

Furthermore, by adopting a structure in which the rear transverse side reinforcement covers both the rear transverse assembly and the back panel, it is possible to improve rigidity and durability of the vehicle body and ensure NVH performance.

Furthermore, the side floor panel and the D-pillar reinforcement may be coupled by the bonding agent for a structure, which may improve connectivity between the back panel, the side floor panel, and a quarter portion and increase framework rigidity of the vehicle body.

Furthermore, by adopting a structure in which the lower end portion of the rear transverse extension member is coupled to the center portion of the rear transverse side reinforcement, it is possible to increase a size of the tailgate opening and improve user convenience.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A back panel assembly, which forms a lower portion of a tailgate opening at a rear side of a vehicle, the back panel assembly comprising:
a back panel extending from the lower portion of the tailgate opening at the rear side of the vehicle in a horizontal direction of a vehicle body and coupled to the vehicle body;
a rear transverse assembly member disposed in the horizontal direction of the vehicle body and coupled to cover a center portion of the back panel;
a rear transverse side reinforcement coupled to a lateral portion of the rear transverse assembly member and extending to the outside of the vehicle; and
a rear transverse extension member coupled to an upper portion of the rear transverse side reinforcement.

2. The back panel assembly of claim 1, further including:
a side floor panel coupled to a side end portion of the rear transverse side reinforcement.

3. The back panel assembly of claim 1, wherein upper and lower end portions of the rear transverse assembly member are coupled to upper and lower portions of the back panel by welding.

4. The back panel assembly of claim 3,
wherein an upper end portion of the rear transverse side reinforcement is coupled to the upper portion of the back panel by welding, and
wherein a lower end portion of the rear transverse side reinforcement is coupled to the lower portion of the back panel by welding.

5. The back panel assembly of claim 4, wherein a lower end portion of the rear transverse extension member is coupled to a center portion of the rear transverse side reinforcement between the upper end portion of the rear transverse side reinforcement and the lower end portion of the rear transverse side reinforcement by welding.

6. The back panel assembly of claim 1,
wherein an upper end portion of the rear transverse side reinforcement is coupled to an upper portion of the back panel by welding, and
wherein a lower end portion of the rear transverse side reinforcement is coupled to a lower portion of the back panel by welding.

7. The back panel assembly of claim 2, wherein an upper portion, a center portion, and a lower portion of an external end portion of the rear transverse side reinforcement are coupled to a surface of the side floor panel by welding.

8. The back panel assembly of claim 1,
wherein an internal end portion of the rear transverse extension member is coupled to the rear transverse assembly member by welding, and
wherein a lower end portion of the rear transverse extension member is coupled to a center portion of the rear transverse side reinforcement.

9. The back panel assembly of claim 1, wherein an upper end portion of the rear transverse extension member is coupled to the vehicle body by bolting.

10. The back panel assembly of claim 1, wherein an external surface of a side floor panel is attached and coupled to a D-pillar reinforcement of the vehicle body by a bonding agent for a structure.

11. The back panel assembly of claim 10, wherein the side floor panel is coupled to a side end portion of the rear transverse side reinforcement.

12. The back panel assembly of claim 11, wherein the bonding agent is positioned between the D-pillar reinforcement and a coupling portion between the rear transverse side reinforcement and the side floor panel and positioned between the side floor panel and the D-pillar reinforcement at a position below the coupling portion.
